(19) United States
(12) Patent Application Publication
(10) Pub. No.: US 2025/0154862 A1
(43) Pub. Date: May 15, 2025

(54) INTELLIGENT MONITORING SYSTEM FOR OIL DEVELOPMENT PLATFORM

(71) Applicant: Ludong University, Yantai (CN)

(72) Inventors: Chao ZHAN, Yantai (CN); Qing WANG, Yantai (CN); Jun ZHU, Yantai (CN); Hongyuan SHI, Yantai (CN); Jun YUE, Yantai (CN); Yan LI, Yantai (CN); Teng SU, Yantai (CN)

(21) Appl. No.: 18/422,016

(22) Filed: Jan. 25, 2024

(30) Foreign Application Priority Data
Nov. 14, 2023 (CN) 2023115167270

(51) Int. Cl. E21B 47/001

(52) U.S. Cl. CPC E21B 47/001; E21B 2200/22

(57) ABSTRACT

Provided is an intelligent monitoring system for an oil development platform. The system includes external environment monitoring of a well platform, internal environment monitoring of the well platform and platform construction, where the external environment monitoring of the well platform includes real-time monitoring of natural environment conditions around an offshore oil development platform, the internal environment monitoring of the well platform includes collection and analysis of various indexes inside the oil well platform, and the platform construction is based on a three-layer structural design including a sensing layer, a transmission layer and an application layer. The sensing layer collects environmental data of ocean and the well platform through an Internet of Things technology, the transmission layer rapidly transmits data to ensure real-time updating of information, and the application layer processes received data to realize fusion and visualization of the data.

### TECHNICAL FIELD

The present disclosure relates to the technical field of oil platform monitoring, and in particular to an intelligent monitoring system for an oil development platform.

### BACKGROUND

In the oil and gas industry, offshore drilling and production activities are quite complex and high-risk operations. Traditional monitoring systems focus on basic operating parameters and safety monitoring, but are relatively weak in environmental monitoring, data integration analysis, and early warning mechanisms, which limits the ability to respond quickly to changes in complex environmental conditions, and increases potential operational and environmental risks.

Firstly, the traditional monitoring systems have limitations in data acquisition and processing. Although some basic physical parameters can be monitored, such as a temperature and a pressure, monitoring capabilities of these systems are relatively limited for more complex environmental conditions inside and outside a well platform, such as ocean fluidity, a wind speed and wind direction, toxic gas leakage, and a formation pressure change. Moreover, data is often collected in a decentralized manner and lacks effective integration, which not only affects real-time performance of the data, but also leads to an omission of critical information.

Secondly, most of early monitoring systems rely on manual monitoring, and lack automated and intelligent data analysis and decision support, and it is difficult for this model to achieve rapid processing and analysis of large-scale, multi-dimensional data. Such systems also lack predictive maintenance and risk assessment functions, so in the case of emergencies, a response is not fast and accurate enough.

Furthermore, most existing systems have no or very basic emergency warning mechanisms. In a complex environment of offshore oil development, a rapid and effective early warning and response mechanism is crucial to minimize the risk of accidents and potential losses. However, traditional technologies are confronted by the problem of lack of detailed risk recognition and prediction models, as well as real-time decision support systems when these challenges are addressed.

### SUMMARY

On the basis of the above objective, the present disclosure provides an intelligent monitoring system for an oil development platform.

The intelligent monitoring system for the oil development platform includes external environment monitoring of a well platform, internal environment monitoring of the well platform and platform construction.

The external environment monitoring of the well platform includes real-time monitoring of natural environment conditions around an offshore oil development platform, and monitored indexes include temperature, humidity, wave height, ocean current, flow velocity, wind speed and wind direction parameters.

The internal environment monitoring of the well platform includes collection and analysis of various indexes inside the oil well platform, and the indexes include a temperature, humidity, a dust condition, a water quality of a water body, toxic gas and a formation pressure.

The platform construction is based on a three-layer structural design including a sensing layer, a transmission layer and an application layer, where the sensing layer collects environmental data of ocean and the well platform through an Internet of Things technology, the transmission layer rapidly transmits data through a satellite technology to ensure real-time updating of information, and the application layer processes received data to realize fusion and visualization of the data, and establishes an intelligent monitoring and early warning unit.

Further, the external environment monitoring of the well platform specifically includes a first sensor network and a first data preprocessing unit, and the first sensor network is deployed at a key external position of the offshore oil development platform and is used for continuously collecting environmental parameters around the offshore oil development platform.

The first sensor network includes a temperature sensor, a humidity sensor, a wave height sensor, a current meter, a wind speed sensor and a wind direction sensor, comprehensively measures and records key variables in a marine environment, and provides real-time monitoring of external environmental conditions of the offshore oil development platform.

The first data preprocessing unit receives raw environmental data from the first sensor network, including temperature, humidity, wave height, ocean current, current velocity, wind speed and wind direction parameters, and processes the data in real time.

Further, the internal environment monitoring of the well platform includes a second sensor network and a second data preprocessing unit.

The second sensor network is distributed at a key position of the oil well platform and includes a temperature sensor, a humidity sensor, a particulate matter sensor, a water quality analysis sensor, a toxic gas detector and a pressure gauge, and comprehensively collects internal environmental data of the well platform.

The second data preprocessing unit receives real-time data collected from the second sensor network, including a temperature, humidity, a dust level, a water quality, a toxic gas concentration and a formation pressure, and monitors whether parameters have deviations or not.

Further, the sensing layer is established based on the first sensor network and the second sensor network.

The transmission layer uses satellite communication and submarine optical cables to realize real-time transmission of data, ensuring that all the data collected from the sensing layer is capable of being safely transmitted to the application layer for analysis. The transmission layer also has a redundancy mechanism and an error recovery function to ensure continuity of data transmission under critical conditions and avoid data loss or delay.

The application layer receives the data sent from the transmission layer and analyzes the data by using advanced data analysis, artificial intelligence and machine learning technologies. The application layer generates real-time reports and early warnings, automatically identifies potential safety risks and operational efficiency problems, and provides clear action guidelines to an operator. The application layer also supports custom reports and multi-dimensional analysis to help a management layer make decisions and long-term planning.

Further, the redundancy mechanism and the error recovery function of the transmission layer are used for maintaining stability and continuity of data transmission in a complex and varied offshore environment.

The redundancy mechanism: a multi-channel and multi-path data transmission strategy is employed, a plurality of backup data transmission paths simultaneously exist on a physical link. When a main communication link has a fault, a backup data transmission path is automatically switched to ensure that the data is not lost due to a fault of a single point. The multi-channel and multi-path data transmission strategy includes different types of communication channels. The communication channels include satellites, submarine optical cables and wireless radio frequencies to ensure that other links are capable of immediately taking over a data transmission task when one link is damaged.

The error recovery function: through built-in error detection and correction algorithm, errors or damage in the process of data transmission are monitored in real time, and corrective measures are automatically taken. When data packet loss or an error is detected, a request is automatically sent again to ensure integrity and accuracy of information. The transmission layer further includes data packet sorting and reassembly functions, and in a complex network environment, disorder of data packets is dealt with to ensure that the data which is finally transmitted to the application layer is complete and untampered.

Further, the advanced data analysis, artificial intelligence and machine learning capabilities of the application layer are used for performing in-depth analysis and intelligent processing on the data collected from the sensing layer and transmitted through the transmission layer, which specifically includes:

Advanced data analysis: the application layer integrates advanced data analysis tools to process large-scale and multi-dimensional data sets, including real-time data streams and historical data, and performs data cleaning, normalization, anomaly detection and complex statistical analysis, so as to recognize key information points and make accurate assessments on an operating status of the offshore oil development platform.

Artificial intelligence and machine learning: the application layer uses artificial intelligence algorithms and machine learning models to automatically learn and recognize patterns and trends in an oil development process, predict potential risks and fault points through data training, achieve predictive maintenance, and reduce apparatus faults and unplanned downtime.

Real-time strategy support: the application layer provides decision support based on results of real-time analysis, automatically triggers alarms or gives operational recommendations to help the operator respond.

Further, the machine learning model is based on a support vector machine, and considering a case of a linear separability, an objective function of the support vector machine is:

$${min}_{w} \frac{1}{2} {‖ w ‖}^{2} .$$

A constraint condition is: yᵢ(w·xᵢ+b)≥1, where

w represents a normal vector, and determines a direction of a hyperplane. xᵢ represents a data point, yᵢ represents a class label of the data point, and b represents a bias term. For a case of a linear inseparability, a relaxation variable and a penalty parameter C are introduced, and the objective function and the constraint condition are adjusted accordingly.

Further, the application layer further includes a visualization tool, and the visualization tool provides an intuitive dashboard to enable the operator to understand a current operating environment, an apparatus health status, and safety alarms.

Further, establishment of the intelligent monitoring and early warning unit specifically includes:
creating an intelligent monitoring framework: analyzing data trends and potential anomalies by using time series analysis from the data collected from the sensing layer and the transmission layer to construct the intelligent monitoring framework;
implementing a real-time monitoring and early warning system: implementing a real-time warning unit within the intelligent monitoring framework, where the unit monitors a continuous data stream and compares same with established thresholds, detects readings exceeding normal parameters, automatically triggers alarms and notifies the operator through a visual/audio signal; and
establishing an emergency response process: establishing a standardized emergency response process to take immediate action when an alarm is triggered.

The present disclosure has following beneficial effects:

According to the present disclosure, by integrating multi-parameter real-time monitoring of the external environment of the well platform and the internal environment of the well platform, the system can comprehensively master the operating status of the offshore oil development platform, the external monitoring ensures tracking of the natural environmental factors such as important meteorology and sea conditions, and the internal monitoring pays attention to safety, operating parameters and environmental qualities of platform facilities, such that risks of safety accidents caused by environmental factors and internal faults is effectively reduced.

According to the present disclosure, the real-time data collection and transmission function of the system, and the advanced data analysis and artificial intelligence algorithm at the application layer jointly ensure the immediate response to abnormal situations. Through learning and pattern recognition of a large amount of historical data, the system has the ability to predict potential faults and dangerous situations, which makes preventive maintenance and emergency response preparation possible.

According to the present disclosure, when key parameter abnormalities are recognized or potential risks are predicted, the system not only automatically sends out an early warning, but also triggers a preset emergency response program. Such an automatic and intelligent operation reduces manual delay and operation errors, accelerates an accident processing speed, and greatly improves emergency processing efficiency.

According to the present disclosure, through careful monitoring of the oil development platform, the system is helpful in realizing early detection and a rapid response to possible environmental pollution sources, such as leakage and toxic gas release, so as to reduce a potential impact on the marine environment.

### BRIEF DESCRIPTION OF THE DRAWINGS

In order to more clearly describe the technical solutions in the present disclosure or the prior art, a brief introduction to the accompanying drawings required for the description of the examples or the prior art will be provided below. Obviously, the accompanying drawings in the following description are merely some accompanying drawings of the present disclosure. Those of ordinary skill in the art can also derive other accompanying drawings from these accompanying drawings without making inventive efforts.

FIG. 1 is a schematic diagram of unit modules of a system according to an embodiment of the present disclosure.

FIG. 2 is a schematic diagram of data of external environment monitoring and internal environment monitoring of a well platform according to an embodiment of the present disclosure.

### DETAILED DESCRIPTION OF THE EMBODIMENTS

In order to make the objective, the technical solutions and the advantages of the present disclosure clearer, the present disclosure is further described in detail below with reference to the particular examples.

It should be noted that, unless otherwise defined, technical or scientific terms used in the present disclosure shall have the ordinary meaning understood by those of ordinary skill in the art to which the present disclosure pertains. The terms “first”, “second”, and similar words used in the present disclosure do not denote any order, quantity, or importance, but are merely used for distinguishing between different components. Words such as “comprise”, “include” or “contain” mean that elements or objects appearing before the word encompass elements or objects listed after the word and equivalents thereof, but do not exclude other elements or objects. Words such as “connecting” or “connection” are not limited to physical or mechanical connections, but may include electrical connections, whether direct or indirect connections. Words “up”, “down”, “left”, “right”, etc. are only used for indicating relative positional relationships, and when the absolute position of the described object changes, the relative positional relationships may change accordingly.

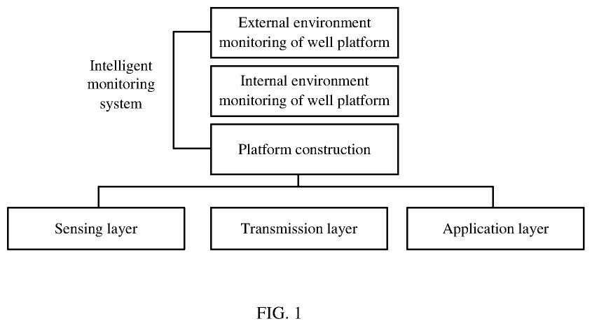

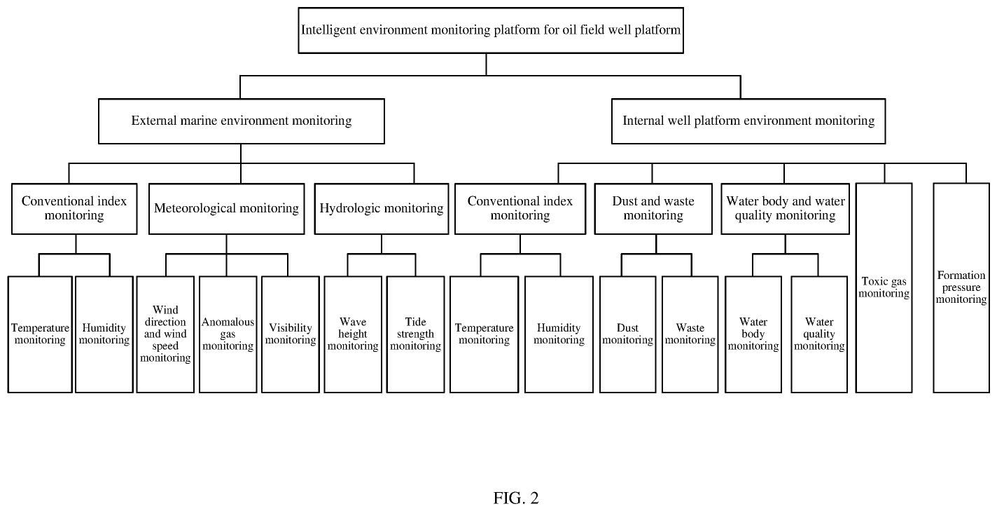

As shown in FIG. 1 and FIG. 2, an intelligent monitoring system for an oil development platform includes external environment monitoring of a well platform, internal environment monitoring of the well platform and platform construction, which form a comprehensive and high-efficiency monitoring network. This system can ensure safety and high efficiency of an oil development process while reducing potential environmental risks.

The external environment monitoring of the well platform includes real-time monitoring of natural environment conditions around an offshore oil development platform, and monitored indexes include temperature, humidity, wave height, ocean current, current velocity, wind speed and wind direction parameters. These data is essential to ensure a stable operation of the offshore oil development platform and safety of employees.

The internal environment monitoring of the well platform includes collection and analysis of various indexes inside the oil well platform, and the indexes include a temperature, humidity, a dust condition, a water quality of a water body, toxic gas and a formation pressure. This information helps prevent possible industrial accidents and ensures a smooth drilling operation.

The platform construction is based on a three-layer structural design including a sensing layer, a transmission layer and an application layer, where the sensing layer collects environmental data of ocean and the well platform through an Internet of Things technology, the transmission layer rapidly transmits data through a satellite technology to ensure real-time updating of information, and the application layer processes received data to realize fusion and visualization of the data, and establishes an intelligent monitoring and early warning unit. This layered design enables the system not only to monitor a complex offshore environment, but also to respond effectively to possible emergencies, thereby greatly improving safety and efficiency of oil development.

The external environment monitoring of the well platform specifically includes a first sensor network and a first data preprocessing unit the first sensor network is deployed at a key external position of the offshore oil development platform and is used for continuously collecting environmental parameters around the offshore oil development platform.

The first sensor network includes a temperature sensor, a humidity sensor, a wave height sensor, a current meter, a wind speed sensor and a wind direction sensor, comprehensively measures and records key variables in a marine environment, and provides real-time monitoring of external environmental conditions of the offshore oil development platform.

The first data preprocessing unit receives raw environmental data from the first sensor network, including temperature, humidity, wave height, ocean current, current velocity, wind speed and wind direction parameters, and processes the data in real time.

The internal environment monitoring of the well platform includes a second sensor network and a second data preprocessing unit.

The second sensor network is distributed at a key position of the oil well platform and includes a temperature sensor, a humidity sensor, a particulate matter sensor, a water quality analysis sensor, a toxic gas detector and a pressure gauge, and comprehensively collects internal environmental data of the well platform.

The second data preprocessing unit receives real-time data collected from the second sensor network, including a temperature, humidity, a dust level, a water quality, a toxic gas concentration and a formation pressure, and monitors whether parameters have deviations or not.

Through such highly integrated monitoring and analysis, the intelligent monitoring system for the oil development platform has an unprecedented ability to ensure operational safety and respond to environmental changes, thereby realizing efficient management and real-time monitoring of various key indexes inside the well platform.

The sensing layer is established based on the first sensor network and the second sensor network.

The transmission layer uses satellite communication and submarine optical cables to realize real-time transmission of data, ensuring that all the data collected from the sensing layer is capable of being safely transmitted to the application layer for analysis. The transmission layer also has a redundancy mechanism and an error recovery function to ensure continuity of data transmission under critical conditions and avoid data loss or delay.

The application layer receives the data sent from the transmission layer and analyzes the data by using advanced data analysis, artificial intelligence and machine learning technologies. The application layer generates real-time reports and early warnings, automatically identifies potential safety risks and operational efficiency problems, and provides clear action guidelines to an operator. The application layer also supports custom reports and multi-dimensional analysis to help a management layer make decisions and long-term planning.

The redundancy mechanism and the error recovery function of the transmission layer are used for maintaining stability and continuity of data transmission in a complex and varied offshore environment.

The redundancy mechanism: a multi-channel and multi-path data transmission strategy is employed, a plurality of backup data transmission paths simultaneously exist on a physical link. When a main communication link has a fault, a backup data transmission path is automatically switched to ensure that the data is not lost due to a fault of a single point. The multi-channel and multi-path data transmission strategy includes different types of communication channels. The communication channels include satellites, submarine optical cables and wireless radio frequencies to ensure that other links are capable of immediately taking over a data transmission task when one link is damaged.

The error recovery function: through built-in error detection and correction algorithm, errors or damage in the process of data transmission are monitored in real time, and corrective measures are automatically taken. When data packet loss or an error is detected, a request is automatically sent again to ensure integrity and accuracy of information. The transmission layer further includes data packet sorting and reassembly functions, and in a complex network environment, disorder of data packets is dealt with to ensure that the data which is finally transmitted to the application layer is complete and untampered.

According to real-time analysis of a network bandwidth and a connection quality, the system can dynamically adjust data transmission parameters, such as modifying a packet size, adjusting a transmission rate or changing a data compression ratio, so as to optimize transmission performance under different network environment conditions. In order to further improve reliability and fault recovery ability of the system, the transmission layer implements continuous network performance monitoring and detailed log recording, which not only helps to diagnose and resolve current network problems quickly, but also provides an early warning of possible future problems, thereby achieving preventive maintenance and long-term system optimization.

The advanced data analysis, artificial intelligence and machine learning capabilities of the application layer are used for performing in-depth analysis and intelligent processing on the data collected from the sensing layer and transmitted through the transmission layer, which specifically includes:

Advanced data analysis: the application layer integrates advanced data analysis tools to process large-scale and multi-dimensional data sets, including real-time data streams and historical data, and performs data cleaning, normalization, anomaly detection and complex statistical analysis, so as to recognize key information points and make accurate assessments on an operating status of the offshore oil development platform.

Artificial intelligence and machine learning: the application layer uses artificial intelligence algorithms and machine learning models to automatically learn and recognize patterns and trends in an oil development process, predict potential risks and fault points through data training, achieve predictive maintenance, and reduce apparatus faults and unplanned downtime.

Real-time strategy support: the application layer provides decision support based on results of real-time analysis, automatically triggers alarms or gives operational recommendations to help the operator respond.

The machine learning model is based on a support vector machine, and considering a case of a linear separability, an objective function of the support vector machine is:

$${min}_{w} \frac{1}{2} {‖ w ‖}^{2} .$$

A constraint condition is: yᵢ(w·xᵢ+b)≥1, where

w represents a normal vector, and determines a direction of a hyperplane. xᵢ represents a data point, yᵢ represents a class label of the data point, and b represents a bias term. For a case of a linear inseparability, a relaxation variable and a penalty parameter C are introduced, and the objective function and the constraint condition are adjusted accordingly.

In the oil development platform, suppose there is a series of health data of an apparatus, including a temperature, a pressure, and other indexes, as well as records of whether the apparatus will have a fault in the future. These data is capable of being used for training a support vector machine model. Once the model is trained, the model is capable of being used for predicting whether new and unlabeled data points (such as new health readings of the apparatus) are likely to cause an apparatus fault.

The application layer further includes a visualization tool, and the visualization tool provides an intuitive dashboard to enable the operator to understand a current operating environment, an apparatus health status, and safety alarms.

Establishment of the intelligent monitoring and early warning unit specifically includes:
creating an intelligent monitoring framework: analyzing data trends and potential anomalies by using time series analysis from the data collected from the sensing layer and the transmission layer to construct the intelligent monitoring framework;
implementing a real-time monitoring and early warning system: implementing a real-time warning unit within the intelligent monitoring framework, where the unit monitors a continuous data stream and compares same with established thresholds, automatically triggers alarms if detecting readings exceeding normal parameters and notifies the operator via a visual/audio signal; and
establishing an emergency response process: establishing a standardized emergency response process to take immediate action when an alarm is triggered, such action includes automatic shutdown of an apparatus in an affected region, activation of a safety protocol such as an evacuation procedure, and notification to key personnel about further analysis and responses.

It should be understood by those of ordinary skill in the art that the discussion of any of the above example is exemplary only and is not intended to imply that the scope of the present disclosure is limited to these examples. Technical features from the above examples or from different examples may also be combined within the concept of the present disclosure, steps may be implemented in any order, and there are many other variations of the different aspects of the present disclosure described above, which have not been provided in detail for the sake of brevity.

The present disclosure is intended to cover all such replacements, modifications and variations falling within the broad scope of the claims. Therefore, any omissions, modifications, equivalent replacements, improvements, etc. made within the spirit and principles of the present disclosure should be included within the protection scope of the present disclosure.

What is claimed is:

1. An intelligent monitoring system for an oil development platform, comprising external environment monitoring of a well platform, internal environment monitoring of the well platform and platform construction;
the external environment monitoring of the well platform comprises real-time monitoring of natural environment conditions around an offshore oil development platform, and monitored indexes comprise temperature, humidity, wave height, ocean current, current velocity, wind speed and wind direction parameters;
the internal environment monitoring of the well platform comprises collection and analysis of various indexes inside the oil well platform, and the indexes comprise a temperature, humidity, a dust condition, a water quality of a water body, toxic gas and a formation pressure; and
the platform construction is based on a three-layer structural design comprising a sensing layer, a transmission layer and an application layer, wherein the sensing layer collects environmental data of ocean and the well platform through an Internet of Things technology, the transmission layer rapidly transmits data through a satellite technology to ensure real-time updating of information, and the application layer processes received data to realize fusion and visualization of the data, and establishes an intelligent monitoring and early warning unit.

2. The intelligent monitoring system for the oil development platform according to claim 1, wherein the external environment monitoring of the well platform specifically comprises a first sensor network and a first data preprocessing unit, and the first sensor network is deployed at a key external position of the offshore oil development platform and is used for continuously collecting environmental parameters around the offshore oil development platform;
the first sensor network comprises a temperature sensor, a humidity sensor, a wave height sensor, a current meter, a wind speed sensor and a wind direction sensor, comprehensively measures and records key variables in a marine environment, and provides real-time monitoring of external environmental conditions of the offshore oil development platform; and
the first data preprocessing unit receives raw environmental data from the first sensor network, comprising temperature, humidity, wave height, ocean current, current velocity, wind speed and wind direction parameters, and processes the data in real time.

3. The intelligent monitoring system for the oil development platform according to claim 2, wherein the internal environment monitoring of the well platform comprises a second sensor network and a second data preprocessing unit;
the second sensor network is distributed at a key position of the oil well platform and comprises a temperature sensor, a humidity sensor, a particulate matter sensor, a water quality analysis sensor, a toxic gas detector and a pressure gauge, and comprehensively collects internal environmental data of the well platform; and
the second data preprocessing unit receives real-time data collected from the second sensor network, comprising a temperature, humidity, a dust level, a water quality, a toxic gas concentration and a formation pressure, and monitors whether parameters have deviations or not.

4. The intelligent monitoring system for the oil development platform according to claim 3, wherein the sensing layer is established based on the first sensor network and the second sensor network;
the transmission layer uses satellite communication and submarine optical cables to realize real-time transmission of data, ensuring that all the data collected from the sensing layer is capable of being safely transmitted to the application layer for analysis, and the transmission layer also has a redundancy mechanism and an error recovery function to ensure continuity of data transmission under critical conditions and avoid data loss or delay; and
the application layer receives the data sent from the transmission layer and analyzes the data by using advanced data analysis, artificial intelligence and machine learning technologies, the application layer generates real-time reports and early warnings, automatically identifies potential safety risks and operational efficiency problems, and provides clear action guidelines to an operator, and the application layer also supports custom reports and multi-dimensional analysis to help a management layer make decisions and long-term planning.

5. The intelligent monitoring system for the oil development platform according to claim 4, wherein the redundancy mechanism and the error recovery function of the transmission layer are used for maintaining stability and continuity of data transmission in a complex and varied offshore environment;
the redundancy mechanism: a multi-channel and multi-path data transmission strategy is employed, a plurality of backup data transmission paths simultaneously exist on a physical link, when a main communication link has a fault, a backup data transmission path is automatically switched to ensure that the data is not lost due to a fault of a single point, the multi-channel and multi-path data transmission strategy comprises different types of communication channels, and the communication channels comprise satellites, submarine optical cables and wireless radio frequencies for other links being capable of immediately taking over a data transmission task when one link is damaged;
the error recovery function: through built-in error detection and correction algorithm, errors or damage in the process of data transmission are monitored in real time, and corrective measures are automatically taken; when data packet loss or an error is detected, a request is automatically sent again to ensure integrity and accuracy of information; and the transmission layer further comprises data packet sorting and reassembly functions, and in a complex network environment, disorder of data packets is dealt with to ensure that the data which is finally transmitted to the application layer is complete and untampered.

6. The intelligent monitoring system for the oil development platform according to claim 5, wherein the advanced data analysis, artificial intelligence and machine learning capabilities of the application layer are used for performing in-depth analysis and intelligent processing on the data collected from the sensing layer and transmitted through the transmission layer, which specifically comprises:
advanced data analysis: the application layer integrates advanced data analysis tools to process large-scale and multi-dimensional data sets, comprising real-time data streams and historical data, and performs data cleaning, normalization, anomaly detection and complex statistical analysis, so as to recognize key information points and make accurate assessments on an operating status of the offshore oil development platform;
artificial intelligence and machine learning: the application layer uses artificial intelligence algorithms and machine learning models to automatically learn and recognize patterns and trends in an oil development process, predict potential risks and fault points through data training, achieve predictive maintenance, and reduce apparatus faults and unplanned downtime; and
real-time strategy support: the application layer provides decision support based on results of real-time analysis, automatically triggers alarms or gives operational recommendations to help the operator respond.

7. The intelligent monitoring system for the oil development platform according to claim 6,
wherein the machine learning model is based on a support vector machine, and considering a case of a linear separability, an objective function of the support vector machine is:
min_{w}½∥w∥²; and
a constraint condition is: yᵢ(w·xᵢ+b)≥1, wherein
w represents a normal vector, and determines a direction of a hyperplane, xᵢ represents a data point, yᵢ represents a class label of the data point, b represents a bias term, for a case of a linear inseparability, a relaxation variable and a penalty parameter C are introduced, and the objective function and the constraint condition are adjusted accordingly.

8. The intelligent monitoring system for the oil development platform according to claim 7, wherein the application layer further comprises a visualization tool, and the visualization tool provides an intuitive dashboard to enable the operator to understand a current operating environment, an apparatus health status, and safety alarms.

9. The intelligent monitoring system for the oil development platform according to claim 8, wherein establishment of the intelligent monitoring and early warning unit comprises:
creating an intelligent monitoring framework: analyzing data trends and potential anomalies by using time series analysis from the data collected from the sensing layer and the transmission layer to construct the intelligent monitoring framework;
implementing a real-time monitoring and early warning system: implementing a real-time warning unit within the intelligent monitoring framework, wherein the unit monitors a continuous data stream and compares same with established thresholds, detects readings exceeding normal parameters, automatically triggers an alarm and notifies the operator through a visual/audio signal; and
establishing an emergency response process: establishing a standardized emergency response process to take immediate action when an alarm is triggered.
